(19) United States
(12) Patent Application Publication
(10) Pub. No.: US 2003/0229658 A1
(43) Pub. Date: Dec. 11, 2003

(54) Method of pattern lossless compression

(76) Inventor: David W. Guidry, Dallas, TX (US)

Correspondence Address: TEXAS INSTRUMENTS INCORPORATED, P O BOX 655474, M/S 3999, DALLAS, TX, 75265

(21) Appl. No.: 10/162,677

(22) Filed: Jun. 6, 2002

(51) Int. Cl. G06F 1/02

(52) U.S. Cl. 708/272

(57) ABSTRACT

A sin (x) or cos (x) computational generator is provided by a coarse and fine storage element sharing a common address bus with the coarse storage element storing full precision values for every J^{th} sample and said fine storage element storing correction values between the J^{th} samples. An arithmetic block operates on the output of the storage elements in response to addresses on the address bus to provide full precision values without storing full precision values.

### FIELD OF INVENTION

This invention relates to a method of pattern lossless compression.

### BACKGROUND OF INVENTION

Digital pattern generators for digital-to-analog converter (DAC) testing have traditionally required a different pattern set for each test frequency. Looping a sequentially addressed pattern creates a coherent sinusoidal stimulus for the device under test (DUT). Changing digital patterns is a major source of test time for automated bench characterization.

If the data set is addressed non-sequentially in such a fashion that only every Nth point is taken, a single pattern can be used to generate all coherent test frequencies (i.e. Fourier bins). The necessary pattern memory depth is the same as the conventional method, but requires loading only once before the test is begun.

Since the pattern is constant throughout all tests, techniques can be employed to compress the look-up table (LUT) memory required for a given pattern depth. This invention describes a lossless method to significantly reduce the size of this LUT memory without any reduction in performance.

Older testers incorporated a step function that allowed non-sequential addressing of a loaded pattern. The address controller is composed of a counter type structure that has a programmable modulus (step size). During test runtime the modulus is modified, allowing the addressing of every N^{th} pattern. If the pattern memory is loaded with a single cycle of a sinusoid, reprogramming the modulus parameter can generate all coherent Fourier bins. High frequency resolution requires large pattern memory, which is not a problem for the testers. A significant reduction in required memory can, however, allow implementation of this method in other kinds of systems (i.e. FPGA, ASIC, DSP, etc.).

Direct Digital Synthesis (DDS) based synthesizers as illustrated in FIG. 1 expand on the concept of N^{th} pattern addressing by allowing fractional step sizes. This is possible because the address controller (variable modulus digital counter) has extra least significant bits (LSBs) that are not connected to the LUT memory. In effect, these extra counter bits act like a decimal place, making fractional step sizes possible. Fractional step sizes are actually a combination of integer step sizes that average out over time to a fractional value. This method is not normally used in DAC testing because the frequencies can be non-coherent (require windowing for analysis). Fractional step sizes can also cause distortion and jitter because of the alternation of integer steps. These problems can be reduced by making the LUT memory large with respect to the DAC resolution (usually 4 to 16 times the number of DAC codes).

Many methods have been devised to compress LUTs for DDS applications. These schemes use trigonometric approximations, Taylor series expansions or iterative computational architectures to achieve aggressive compression ratios (over 50:1 is not uncommon.) These methods are, however, all lossy and thus add distortion to the sinusoidal pattern. Since linearity performance is a tradeoff of architecture and LUT size, these methods are acceptable for use in a DDS system as long as the induced distortion is small compared to the DAC's inherent distortion. Mixed signal testing and characterization require very precise sample sets to insure accurate, uniform and correlative assessment of device performance. This requirement usually disqualifies these techniques for use in DAC characterization.

### SUMMARY OF INVENTION

In accordance with one embodiment of the present invention a pattern is losslessly compressed by full precision values for every J^{th} sample and providing “delta” correction values for every final sample between each J^{th} sample to correct for the final sample values in-between and a summer for summing the results so the full samples do not initially need to be provided to maintain the performance.

In accordance with another embodiment of the present invention the pattern is losslessly compressed by a coarse LUT and a fine LUT and a summer for summing the results so a deep memory requirement can be eliminated while maintaining the performance.

In accordance with another embodiment of the present invention a pattern is losslessly compressed for transmission by sending full precision values for every J^{th} sample and sending “delta” correction sample values for every final sample between each J^{th} sample to correct for the samples in-between the J^{th} sample and a summer for summing the results so the full samples do not initially need to be sent to maintain the performance.

### DESCRIPTION OF DRAWINGS

FIG. 1 illustrates the basic Direct Digital Synthesis (DDS) architecture according to the prior art.

FIG. 2 is a block diagram of the system according to one embodiment of the present invention.

FIG. 3 illustrates an example of full, coarse, and correction LUTs.

FIG. 4 illustrates a block diagram of the system according to another embodiment of the present invention.

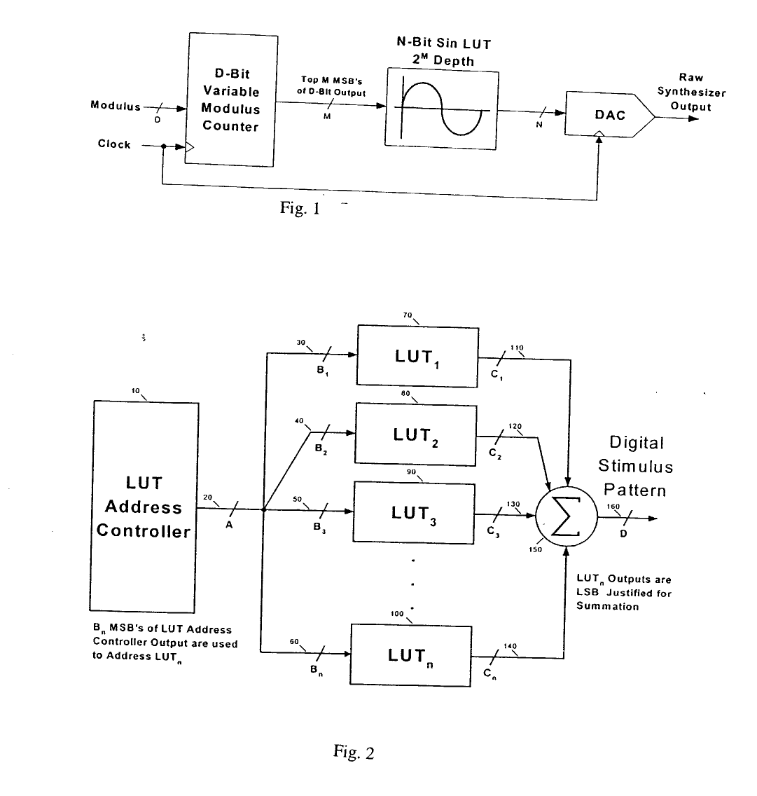

### DESCRIPTION OF PREFERRED EMBODIMENTS OF THE PRESENT INVENTION

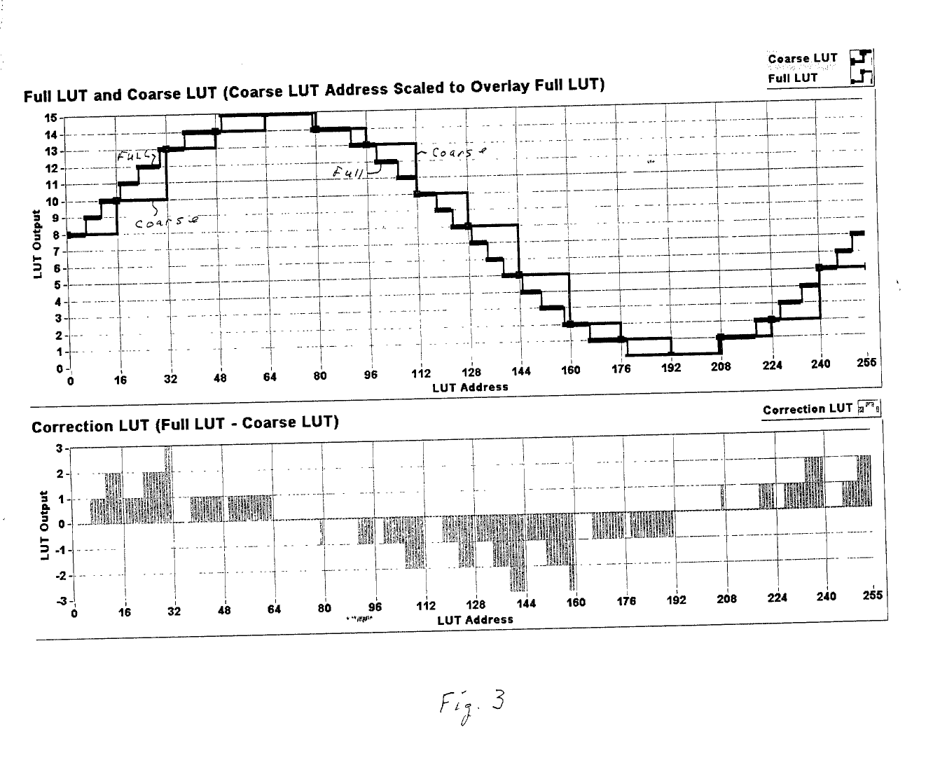

Referring to FIG. 2 the lossless LUT compression system for real-time digital stimulus generators such as a sin (x) or cos (x) computational generator is illustrated. The system includes a LUT address controller 10, a plurality of LUTs (70-100) and a summer 150. The LUT address controller generates an A-bit word (20) each update period that is used to address the LUTs. Each LUT has a width of Cₙ and a depth 2^{B}ₙ so only the top Bₙ-bits of the controller are used for each LUT. The Cₙ-bit outputs of each LUT are LSB justified and summed together to form a D-bit output (160). The Bₙ most significant bits (MSB) of the LUT addresses controller output are used to address the LUTs (LUT₁-LUTₙ). The LUT₁-LUTₙ outputs are least significant bit (LSB) justified for summation.

This architecture allows significant LUT memory reduction because a stored sinusoidal pattern does not substantially change value between consecutive entries. Redundancy can be removed by storing each LUT entry as several varying precision segments that are summed back together to recover each sample. One implementation of this is to store full precision values for every J^{th} sample (coarse LUT) and store “delta” correction samples (fine LUT) at every entry to correct for the samples in-between. A typical implementation of the system would includes only two LUTs 70 and 80 in FIG. 2 with LUT 70 being a coarse LUT and the other LUT 80 a fine LUT. The address -controller 10 addresses over a common bus the coarse LUT 70 and the fine LUT 80. The output is summed at summer 150. By adding or subtracting the delta values from the Fine LUT to the coarse LUT values the summed output provides the full precision result. The LUT outputs are least significant bit (LSB) justified for the summation. Since the correction values are relatively small compared to the full precision entries, they require less memory to store. If spacing between full precision values is chosen correctly, the combination of both memories is much smaller than one full precision LUT.

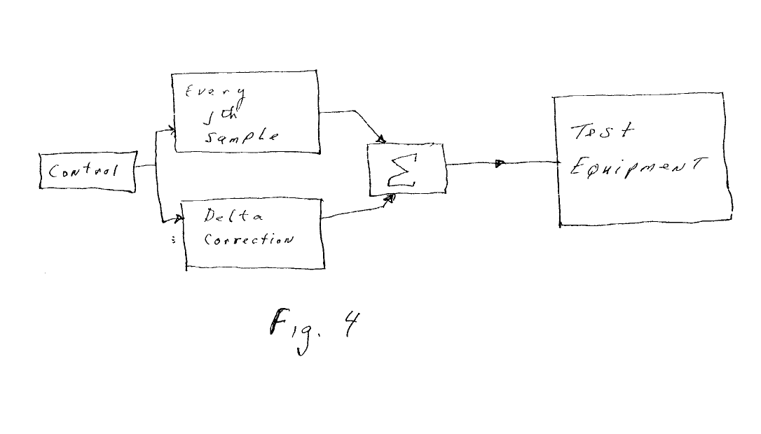

FIG. 3 illustrates this concept with a 4-bit precision, 8-bit depth sinusoidal pattern. Even though 1/16^{th} of the values are stored in the coarse LUT 70, the maximum error value is only ±3 as illustrated in the lower part of the FIG. 3 labeled “Correction LUT”. The fine LUT is represented by LUT 80 in FIG. 2. The coarse LUT which corresponds to LUT 70 in FIG. 2 is represented by the big steps every 16 LUT addresses and the fine LUT 80 every 4 addresses. The maximum error magnitude does not increase with higher precision patterns as long as the relationship between the number of full depth and coarse depth address bits is maintained. This method can be further improved by warping the full precision table so that the error values are always positive. This will relieve the need for a subtraction circuit and will reduce the correction LUT data width by one bit. In the FIG. 3 example of 4-bit precision the error would now be between 0 and 3.

Another example is illustrated in connection with FIG. 2 for an uncompressed LUT of 10-bits by 8192 depth such as would be used for example to test a 10-bit DAC. The coarse LUT 70 would have a 10-bit width and a depth of 1024. The fine LUT 80 would have a 2-bit width and a depth of 8192. This would correspond to A's width being 13, B1's width being 10, B2's width being 13, C1 width being 10, C2's width being 2 and D's width being 10. Since Bₙ is an address, the size of each LUT is 2^{B}ₙ. For the coarse LUT 70 this is 1024 and for the fine LUT 80 this is 8192. A bit is needed to tell the summer to add or subtract the delta or fine table values. This can be eliminated warping the full precision table so that the error values are always positive. Table 1 compares memory requirements for full and compressed LUTs.

TABLE 1
Full vs. Compressed LUT Memory Requirements

| DUT | Full | Full | Coarse | Correction | Coarse + | |
|---|---|---|---|---|---|---|
| Resolu- | LUT | LUT | LUT | LUT | Correction | Com- |
| tion | Depth | Size | Depth | Width | LUT Total | pression |
| (Bits) | (Words) | (Bits) | (Words) | (bits) | Size (bits) | Ratio |
| 8 | 4096 | 32768 | 256 | 2 | 10240 | 3.20 |
| 10 | 16384 | 163840 | 1024 | 2 | 43008 | 3.81 |
| 12 | 65536 | 786432 | 4096 | 2 | 180224 | 4.36 |

A LUT reduction method frequently used in integrated DDS synthesizers is to exploit the quarter wave symmetry of a sinusoid. Only one forth of a cycle needs to be stored; address transposition, subtraction from mid-scale or both can find the other points. This technique can be used in conjunction with the present invention to reduce the LUT size by another factor of four.

Since the primary use of this invention is the generation of sinusoidal digital patterns, it is crucial that a new sample be generated every clock cycle. Since only an adder and segmented memory architecture are required in addition to that of a traditional pattern generator, high clock rates are very attainable.

FIG. 4 illustrates another embodiment of the present invention wherein there is a data transfer such as between a host and test equipment wherein a pattern is losslessly compressed for transmission between a host and test equipment by sending full precision values for every J^{th} sample and sending “delta” correction values at every final sample between each J^{th} sample to correct for the final sample values in-between the J^{th} sample and a summer for summing the results so the full samples do not initially need to be sent to maintain the performance.

Many modifications of the preferred embodiment are possible without exceeding the scope of the present invention, and many of these would be obvious to those skilled in the art. Therefore, although the invention has been described in connection with a preferred embodiment, it will be understood that this description is not intended to limit the invention, but the invention is intended to cover all modifications and alternative constructions falling with the scope of the invention as expressed in the appended claims and their equivalents.

In the claims:

1. A sinusoidal digital pattern generator with reduced LUT memory space comprising:
an address generator;
a coarse storage element storing full precision values for every J^{th} sample and a fine storage element storing correction samples at every entry to provide correction sample sharing a common address bus coupled to said address generator for providing samples in-between; and
an arithmetic block coupled to the output of said storage elements for providing full precision values with less storage.

2. A digital pattern generator comprising:
an address generator;
a plurality of individual storage elements each storing less than full precision values and sharing a common bus;
arithmetic block that operates on the output of the storage elements to provide full precision values..

3. A sin (x) or cos (x) computational generator comprising;
a coarse and fine storage element sharing a common address bus with said coarse storage element storing full precision values for every J^{th} sample and said fine storage element storing correction values between said J^{th} samples; and arithmetic block that operates on the output of said storage elements in response to addresses on said address bus to provide full precision values without storing full precision values.

4. The generator of claim 3 wherein said coarse storage element stored precision values are warped so that the error values are always positive or negative so the arithmetic block is always respectively an positive adder or negative adder.

5. The generator of claim 4 wherein said error values are positive and said arithmetic is a positive.

6. The generator of claim 3 wherein only one fourth of the cycle values is stored and the other points are determined by address transposition, subtraction, subtraction from mid-scale or both.

7. A look up table enabling smaller storage size and faster speed access comprising:
a coarse and fine storage element sharing a common address bus with said coarse storage element storing full precision values for every J^{th} sample and said fine storage element storing correction values between said J^{th} samples; and
an arithmetic block that operates on the output of said storage elements in response to addresses on said address bus to provide full precision values without storing full precision values.

8. A method of compressing a pattern comprising the steps of:
providing full precision values for every J^{th} sample;
providing “delta” correction values for every final sample between each J^{th} sample to correct for the full precision sample values in-between; and
summing the results so the full precision samples do not initially need to be provided to maintain the performance.

9. A method of transmitting a compressed pattern comprising the steps of:
transmitting full precision values for every J^{th} sample;
transmitting “delta” correction sample values for every full precision samples between each J^{th} sample to correct for the samples in-between the J^{th} sample; and
summing the results so the full precision samples do not initially need to be transmitted to maintain the performance.

10. A method of providing a smaller size look up table with fast access comprising the steps of:
storing full precision values for every J^{th} sample;
storing “delta” correction values for every final sample between each J^{th} sample to correct for the full precision sample values in-between; and
summing the results so the full precision samples do not initially need to be stored to maintain the performance.

11. A method of providing a smaller size look up table with fast configuration and frequency modification comprising the steps of:
accessing simultaneously coarse and fine storage elements sharing a common address bus with said coarse storage element storing full precision values for every J^{th} sample and said fine storage element storing correction values between said J^{th} samples; and
summing the output of said storage elements in response to addresses on said address bus to provide full precision values without storing full precision values.
